(19) United States
(12) Patent Application Publication
(10) Pub. No.: US 2023/0318123 A1
(43) Pub. Date: Oct. 5, 2023

(54) POWER STORAGE DEVICE

(71) Applicant: Prime Planet Energy & Solutions, Inc., Tokyo (JP)

(72) Inventor: Harunari SHIMAMURA, Toyonaka-shi (JP)

(21) Appl. No.: 18/155,074

(22) Filed: Jan. 17, 2023

(30) Foreign Application Priority Data
Mar. 31, 2022 (JP) 2022-058764

(51) Int. Cl. H01M 50/342; H01M 50/103

(52) U.S. Cl. CPC H01M 50/3425; H01M 50/103

(57) ABSTRACT

A power storage device includes an electrode body, a case accommodating the electrode body, and a safety valve provided in this case to release gas generated in the case to the outside. The power storage device is further provided with a gas guiding member for guiding gas toward the safety valve when the gas spouts from the electrode body.

### CROSS-REFERENCE TO RELATED APPLICATIONS

This application is based upon and claims the benefit of priority to Japanese Pat. Application No. 2022-058764 filed on Mar. 31, 2022, the entire contents of which are incorporated herein by reference.

### BACKGROUND

### Technical Field

The present disclosure relates to a power storage device in which a case accommodating an electrode body is provided with a safety valve.

### Related Art

Some power storage devices, such as secondary batteries and capacitors, include a case provided with a safety valve. In each of those power storage devices, even if gas is generated in an electrode body, the safety valve is opened when the internal pressure of the case reaches a valve opening pressure, thereby releasing the gas out of the case through the opened safety valve. For example, Japanese unexamined patent application publication No. 2021-121999 discloses such a secondary battery (see FIGS. 1 and 2).

### SUMMARY

### Technical Problems

When gas vigorously spouts from the electrode body inside the case, the spouted gas is released out of the case through the safety valve as mentioned above. However, the spouted gas of high temperature may intensively impinge on a part of the case, and break through the case and is discharged out of the case.

The present disclosure has been made to address the above problems and has a purpose to provide a power storage device capable of preventing release of gas spouted inside a case from an electrode body from breaking through the case and being discharged out of the case.

### Means of Solving the Problems

To achieve the above-mentioned purpose, one aspect of the present disclosure provides a power storage device comprising: an electrode body; a case accommodating the electrode body; a safety valve provided to the case and configured to release gas generated in the case to outside the case; and a gas guiding part for guiding the gas toward the safety valve when the gas spouts from the electrode body.

In the foregoing power storage device, which includes the gas guiding part, the gas spouted inside the case from the electrode body is guided by this gas guiding part toward the safety valve. This configuration can suppress the gas ejected from the electrode body from breaking through the case and being discharged out of the case.

The “power storage device” may include, for example, a secondary battery such as a lithium ion secondary batter, a capacitor such as a lithium ion capacitor, and others.

The “electrode body” may include, for example, a wound electrode body including strip-shaped electrode sheets wound in a cylindrical shape or a flat shape with strip-shaped separators interposed, a laminated electrode body, including a plurality of rectangular electrode sheets stacked in a rectangular parallelepiped shape with separators interposed, and other types of electrode bodies. Further, the power storage device may be provided with a single electrode body or multiple electrode bodies.

The “case” may include, for example, a metal can case, a plastic case, a laminated film case, etc.

The “safety valve” may include, for example, a non-return safety valve that breaks open when the internal pressure of the case exceeds a valve opening pressure, and a return safety valve that opens when the internal pressure of the case exceeds a valve opening pressure, but closes when the internal pressure of the case decreases below the valve opening pressure.

The “gas guiding part” may include, for example, a gas guiding member separately formed from the case and placed in the case, a gas guiding part integrally formed with the case, forming a part of the case.

Furthermore, in the foregoing power storage device, the gas guiding part is formed of a gas guiding member that is a separate body from the case.

In the above-described power storage device, the gas guiding part consists of a gas guiding member separately formed from the case. Since the gas guiding member separate from the case is placed, it is possible to prevent the gas spouted from the electrode body from directly impinging on the case. This configuration can more effectively suppress the spouted gas from breaking through the case and being discharged out of the case.

The “gas guiding member” may be made of materials resistant to the temperatures of gas jet for more than 10 seconds. For such materials, for example, metal materials or ceramic materials are usable and also plastic materials that have a softening point of 100° C. or higher (e.g., acrylic resin, imide acrylic resin, or polyimide resin, having a softening point of 100° C. or higher) are usable.

Furthermore, in any one of the foregoing power storage devices, the case has a rectangular parallelepiped box shape, and includes: a rectangular top wall having a pair of long sides and a pair of short sides; a rectangular bottom wall opposed to the top wall; a pair of long side walls extending individually from the pair of long sides to join the top wall and the bottom wall; and a pair of short side walls extending individually from the pair of short sides to join the top wall and the bottom wall, the electrode body includes electrode sheets and separators, which overlap each other, in which the electrode sheets or the separators have peripheral end portions arranged in a thickness direction to form a pair of peripheral facing surfaces that face the pair of short side walls of the case, the safety valve is placed on the top wall of the case, and the gas guiding part is placed between the short side wall of the case and the peripheral facing surface of the electrode body and is configured to guide the gas toward the top wall when the gas spouts from the peripheral facing surface toward the short side wall.

In the above-described power storage device, the gas guiding part is configured as above. Therefore, when gas spouts toward the short side wall from the peripheral facing surface opposed to the short side wall of the case, among the peripheral end surfaces of the electrode body with the electrode sheets or the separators arranged in the thickness direction, the gas guiding part provided between the short side wall of the case and the peripheral facing surface of the electrode body can guide the spouted gas toward the top wall of the case in which the safety valve is provided. This can prevent the gas spouted from the peripheral facing surface of the electrode body toward the short side wall of the case from breaking through the short side wall and being discharged out of the case.

In a power storage device configured such that the electrode body is a flat wound electrode body, which is accommodated in a case so that a winding axis of the electrode body is vertical to a short side wall of the case, the end faces of the electrode body on opposite sides in the winding axis direction, i.e., a pair of end faces perpendicular to the winding axis, are one example of a pair of peripheral facing surfaces of the present disclosure. Each of the opposite peripheral facing surfaces is formed by the peripheral end portions of the electrode sheets arranged in the thickness direction of the electrode body.

When the electrode body is a flat laminated electrode body, this electrode body has four peripheral end faces formed by the peripheral end portions of the separators that are slightly larger than the electrode sheets and are arranged in the thickness direction of the electrode body. Of the four peripheral end faces, a pair of peripheral end faces, i.e., the peripheral end surfaces facing a pair of short side walls of the case, is one example of a pair of peripheral facing surfaces of the present disclosure.

Still further, in the foregoing power storage device, the gas guiding part includes an inclined portion that: faces over a range of 50% or more of the peripheral facing surface in a top-bottom direction of joining the top wall and the bottom wall; and forms an inclined surface spaced from the peripheral facing surface with a gap wider toward the top wall.

In the above-described power storage device, since the gas guiding part includes the inclined surface that faces over a wide area of the peripheral facing surface of the electrode body as described above, it is possible to allow much of the gas spouted from the peripheral facing surface of the electrode body to flow to the top wall along the inclined surface so that the gas is guided toward the safety valve.

Furthermore, in the foregoing power storage device, the gas guiding part includes the inclined portion that forms the inclined surface facing over all the range of the peripheral facing surface in the top-bottom direction.

In the above-described power storage device, since the gas guiding part includes the inclined surface that faces over a wider area of the peripheral facing surface of the electrode body, it is possible to allow more gas spouted from the peripheral facing surface of the electrode body to flow to the top wall along the inclined surface so that the gas is guided toward the safety valve.

Still further, in any one of the foregoing power storage devices, the inclined surface of the inclined portion is a flat surface, and the inclined surface has an inclination angle of 0.36° or more, the inclination angle being defined by an interior angle of a right triangle having an adjacent side corresponding to a height of the inclined portion and an opposite side corresponding to a difference between a bottom-end thickness of a bottom end portion of the inclined portion on a closest side to the bottom wall of the case and a top-end thickness of a top end portion of the inclined portion on a closest side to the top wall of the case.

In the above-described power storage device, since the inclination angle of the inclined surface is large, this inclined surface allows the gas spouted from the peripheral facing surface of the electrode body to effectively flow toward the top wall and to be guided to the safety valve.

### BRIEF DESCRIPTION OF THE DRAWINGS

FIG. 1 is a perspective view of a battery in first to fourth embodiments;

FIG. 2 is a cross-sectional view of the battery in a battery vertical direction and a battery lateral direction in the first embodiment;

FIG. 3 is an explanatory view showing that gas spouted from a peripheral facing surface of an electrode body toward a short side wall of a case is guided toward a top wall of the case by a gas guiding member in the first embodiment;

FIG. 4 is a perspective view of the gas guiding member in the first embodiment;

FIG. 5 is a perspective view of a gas guiding member in the second embodiment;

FIG. 6 is a perspective view of a gas guiding member in the third embodiment; and

FIG. 7 is a cross-sectional view of a gas guiding part integral with a case in the fourth embodiment.

### DETAILED DESCRIPTION OF THE EXEMPLARY EMBODIMENTS

### First Embodiment

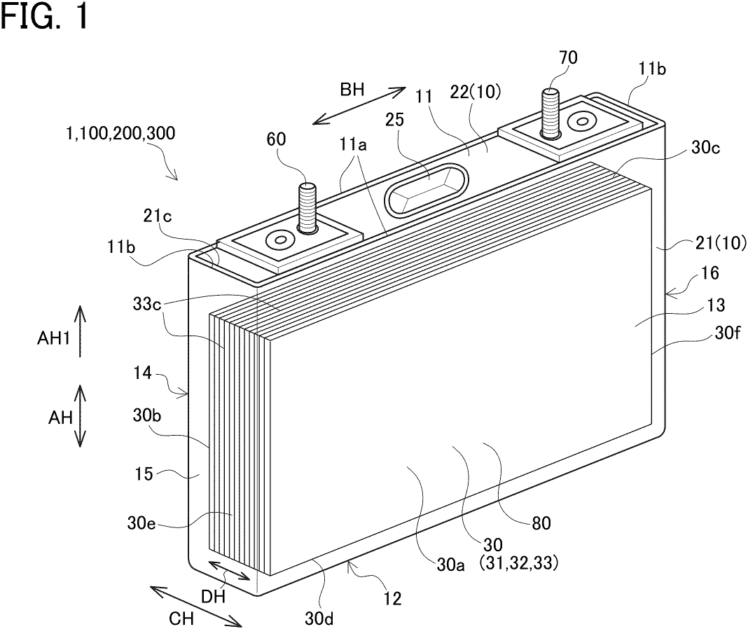

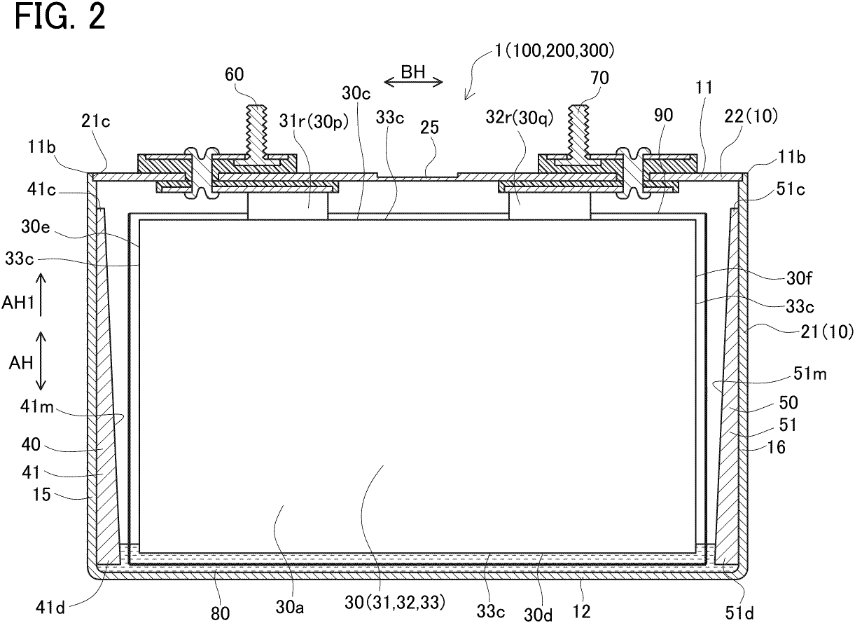

A detailed description of a first embodiment of this disclosure will now be given referring to the accompanying drawings. FIG. 1 is a perspective view of a battery (one example of a power storage device of the present disclosure) 1 in the first embodiment. FIG. 2 is a cross-sectional view of the battery 1. In the following description, the battery vertical direction AH, the battery lateral direction BH, and the battery thickness direction CH of the battery 1 are defined as indicated with arrows in FIGS. 1 and 2. This battery 1 is a rectangular, sealed lithium ion secondary battery, which is mounted in a vehicle, such as a hybrid car, a plug-in hybrid car, and an electric car.

The battery 1 includes a case 10, an electrode body 30 and a pair of gas guiding members (one example of gas guiding parts of the present disclosure) 40 and 50 which are accommodated in the case 10, a positive terminal 60 and a negative terminal 70 which are supported on the case 10, and others. The case 10 is provided with a non-return safety valve 25 that has a thinner thickness than other portions of the case 10 and can break open when the internal pressure of the case 10 exceeds a valve opening pressure to release gas GA generated in the case 10 to the outside thereof. In the case 10, an electrolytic solution 80 is contained, a part of which is impregnated in the electrode body 30 while another part of which is accumulated on a bottom wall 12 of the case 10. The electrode body 30 is covered with a pouch-shaped insulation film 90 that opens on one side AH1 in the vertical direction AH.

The case 10 has a rectangular box-like shape made of metal, which is aluminum in the first embodiment. This case 10 includes a rectangular top wall 11 having a pair of long sides 11a and a pair of short sides 11b, a rectangular bottom wall 12 opposed to the top wall 11, a pair of long side walls 13 and 14 that join between the top wall 11 and the bottom wall 12 and extend from the long sides 11a, and a pair of short side walls 15 and 16 that join between the top wall 11 and the bottom wall 12 and extend from the short sides 11b.

The case 10 is constituted of a case body 21 and a case lid 22. The case body 21 has a bottom-closed rectangular tubular shape with an opening 21c on the one side AH1 in the vertical direction AH, forming the bottom wall 12, the pair of long side walls 13 and 14, and the pair of short side walls 15 and 16. The case lid 22 has a rectangular plate shape and is welded to the case body 21 to close the opening 21c, forming the top wall 11 of the case 10. The case body 21 has a thickness of 0.2 to 3.0 mm (1.0 mm in the present embodiment) and the case lid 22 has a thickness of 0.2 to 3.0 mm (2.0 mm in the present embodiment).

The case body 21 accommodates therein the electrode body 30 covered with the insulation film 90 and gas guiding members 40 and 50.

In contrast, the foregoing safety valve 25 is placed near the center of the case lid 22 in the battery lateral direction BH. The case lid 22 is formed with a liquid inlet (not shown) that provides communication between inside and outside of the case 10. This case lid 22 is hermetically sealed with a sealing member (not shown). To the case lid 22, the positive terminal 60 formed of a plurality of aluminum parts is fixed in an insulating relation from the case lid 22. This positive terminal 60 is connected and conducted to a positive electrode tab 30p mentioned later of the electrode body 30 inside the case 10, while the positive terminal 60 extends to the outside of the battery 1 by passing through the case lid 22. To the case lid 22, further, the negative terminal 70 formed of a plurality of copper parts is fixed in an insulating relation from the case lid 22. This negative terminal 70 is connected and conducted to a negative electrode tab 30q mentioned later of the electrode body 30 within the case 10, while the negative terminal 70 extends to the battery outside by passing through the case lid 22.

The electrode body 30 is a laminated electrode body having a flat, rectangular parallelepiped shape, in which a plurality of rectangular positive electrode sheets (one example of electrode sheets of the present disclosure) 31 and a plurality of rectangular negative electrode sheets (one example of electrode sheets of the present disclosure) 32 are alternately laminated with rectangular separators 33 interposed therebetween in the thickness direction DH of the electrode body 30. The separators 33 are porous films made of resin. Each negative electrode sheet 32 is slightly larger than each positive electrode sheet 31. Each separator 33 is slightly larger than each negative electrode sheet 32. The positive electrode sheets 31 and the separators 33 alternately overlapping in the thickness direction DH are bonded with adhesive, and similarly the negative electrode sheets 32 and the separators 33 alternately overlapping in the thickness direction DH are bonded with adhesive. Thus, the electrode body 30 is integrated.

This electrode body 30 has six flat faces. Specifically, the electrode body 30 includes a pair of flat surfaces 30a and 30b each perpendicular to the thickness direction DH, i.e., located outside in the thickness direction DH, and four peripheral end surfaces 30c, 30d, 30e, and 30f, which join the flat surfaces 30a and 30b. To ensure electrical insulation, the separators 33 each have a rectangular shape slightly larger over the entire circumference than the positive electrode sheets 31 and the negative electrode sheets 32. Each of the peripheral end surfaces 30c, 30d, 30e, and 30f of the electrode body 30 is a face formed by peripheral edges 33c of the separators 33 arranged in the thickness direction DH of the electrode body 30.

Among the peripheral end surfaces 30c, 30d, 30e, and 30f, the peripheral end surfaces 30e and 30f are one example of a peripheral facing surface of the present disclosure. Specifically, in the battery 1, the flat surface 30a of the electrode body 30 faces the long side wall 13 of the case 10, and the flat surface 30b of the electrode body 30 faces the long side wall 14 of the case 10. The peripheral end surface 30c of the electrode body 30 faces the top wall 11 of the case 10, and the peripheral end surface 30d of the electrode body 30 faces the bottom wall 12 of the case 10. Further, the peripheral end surface (the peripheral facing surface) 30e faces the short side wall 15 of the case 10, and the peripheral end surface (the peripheral facing surface) 30f faces the short side wall 16 of the case 10.

The positive electrode sheets 31 each include a positive current collecting foil (not shown) formed of a rectangular aluminum foil and a positive active material layer (not shown) provided on each main surface of the foil. The positive active material layer consists of positive active material particles that can absorb and release lithium ions, conductive particles, and a binding agent. Each positive electrode sheet 31 has an extended portion extending on the one side AH1 in the vertical direction AH, which is a positive-electrode exposed portion 31r formed of the positive current collecting foil exposed in the thickness direction without being applied with the positive active material layers in the thickness direction. The positive-electrode exposed portions 31r of the positive electrode sheets 31 overlap each other in the thickness direction, forming the positive electrode tab 30p. This positive electrode tab 30p is connected to the positive terminal 60 as described above.

The negative-electrode electrode sheets 32 each include a negative current collecting foil (not shown) formed of a rectangular copper foil and a negative active material layer (not shown) provided on each main surface of the foil. The negative active material layer consists of negative active material particles that can absorb and release lithium ions and a binding agent. Each negative-electrode electrode sheet 32 has an extended portion extending on the one side AH1 in the vertical direction AH, which is a negative-electrode exposed portion 32r formed of a negative current collecting foil exposed in the thickness direction without being applied with the negative active material layer in the thickness direction. The negative-electrode exposed portions 32r of the negative electrode sheets 32 overlap each other in the thickness direction, forming the negative electrode tab 30q. This negative electrode tab 30q is connected to the negative terminal 70 as described above.

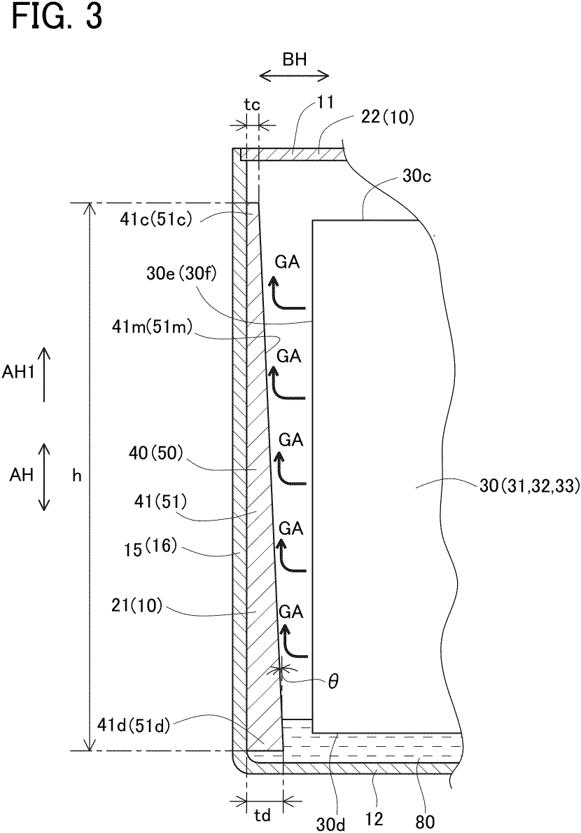

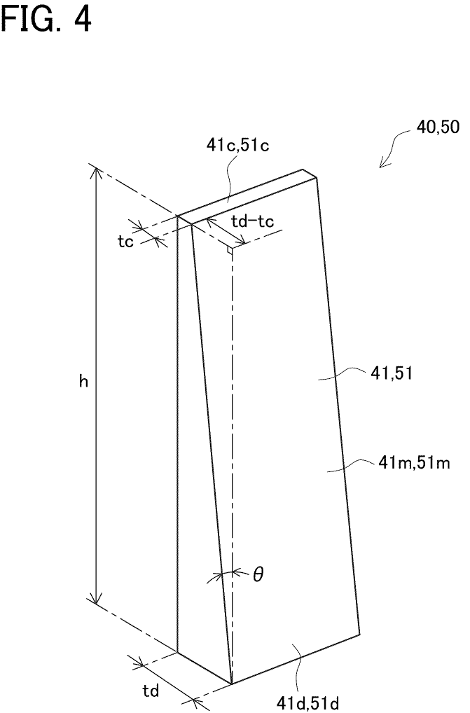

The gas guiding members 40 and 50 will be described below, additionally referring to FIGS. 3 and 4. These gas guiding members 40 and 50 serve to guide gas GA toward the safety valve 25 if the gas GA spouts from the electrode body 30. In the first embodiment, the gas guiding members 40 and 50 are separate bodies (e.g., aluminum components in the first embodiment) from the case 10.

The gas guiding member 40 on one side is provided between the short side wall 15 of the case 10 and the peripheral facing surface 30e of the electrode body 30 and configured to guide the gas GA, spouted from the peripheral facing surface 30e of the electrode body 30 toward the short side wall 15 of the case 10, to flow toward the top wall 11 of the case 10, i.e., toward the safety valve 25.

The gas guiding member 50 on the other side is provided between the short side wall 16 of the case 10 and the peripheral facing surface 30f of the electrode body 30 and configured to guide the gas GA, spouted from the peripheral facing surface 30f of the electrode body 30 toward the short side wall 16 of the case 10, to flow toward the top wall 11 of the case 10, i.e., toward the safety valve 25.

The gas guiding members 40 and 50 are identical in structure and thus only the gas guiding member 40 will be described below, accompanied by reference signs of corresponding components or parts of the gas guiding member 50 in parentheses.

Specifically, the gas guiding member 40 (50) includes an inclined portion 41 (51) having a schematically plate-like shape with an inclined surface 41m (51m) which is a flat surface. The inclined portion 41 (51) is progressively thinner in thickness from a bottom end portion 41d (51d) on the side closest to the bottom wall 12 to a top end portion 41c (51c) on the side closest to the top wall 11. The inclined surface 41m (51m) of the inclined portion 41 (51) faces a range of 50% or more (the entire range (100%) in the present embodiment) of the peripheral facing surface 30e (30f) of the electrode body 30 in a top-bottom direction (i.e., a battery vertical direction) AH of joining the top wall 11 and the bottom wall 12. The gap between the inclined surface 41m (51m) and the peripheral facing surface 30e (30f) of the electrode body 30 is wider toward the top wall 11, i.e., the one side AH1 in the battery vertical direction AH.

The dimensions of the inclined portion 41 (51) are set as follows: the top-end thickness tc of the top end portion 41c (51c) is 0.5 mm, the bottom-end thickness td of the bottom end portion 41d (51d) is 2.0 mm, and the height (in the top-bottom direction AH) is 95 mm. Further, the inclined surface 41m (51m) has an inclination angle θ of 0.36° or more (θ=0.91° in the present embodiment). This inclination angle θ is defined by the interior angle of a right triangle having an adjacent side corresponding to the height h of the inclined portion 41 (51) and an opposite side corresponding to a difference (td - tc) between the bottom-end thickness td and the top-end thickness tc.

If high-temperature gas GA spouts from the peripheral facing surface 30e of the electrode body 30 toward the short side wall 15 of the case 10, the insulation film 90 enclosing the electrode body 30 is first melted due to the heat of the gas GA. This gas GA impinges on the inclined surface 41m of the gas guiding member 40 (the inclined portion 41) and then flows along the inclined surface 41m toward the top wall 11 provided with the safety valve 25 as shown in FIG. 3. Accordingly, it is possible to prevent the gas GA spouted from the peripheral facing surface 30e of the electrode body 30 from breaking through the short side wall 15 of the case 10 and being released out of the case 10.

Furthermore, if high-temperature gas GA spouts from the peripheral facing surface 30f of the electrode body 30 toward the short side wall 16 of the case 10, the insulation film 90 is first melted due to the heat of the gas GA as described above and then the gas GA impinges on the inclined surface 51m of the inclined portion 51 of the gas guiding member 50 and further flows along the inclined surface 51m toward the top wall 11 provided with the safety valve 25. Accordingly, it is possible to prevent the gas GA spouted from the peripheral facing surface 30f of the electrode body 30 from breaking through the short side wall 16 of the case 10 and being released out of the case 10.

Next, the method for manufacturing the foregoing battery 1 will be described below. The electrode body 30 is first produced by stacking the positive electrode sheets 31, the negative electrode sheets 32, and the separators 33 in the thickness direction DH. The positive terminal 60 and the negative terminal 70 are then fixed to the case lid 22. Those terminals 60 and 70 are connected respectively to the positive electrode tab 30p and the negative electrode tab 30q of the electrode body 30 by welding. Then, the electrode body 30 is enclosed in the pouch-shaped insulation film 90.

In a separate way, the gas guiding members 40 and 50 are placed in the case body 21 and fixed respectively to the short side walls 15 and 16 with adhesive. The electrode body 30 covered with the insulation film 90 is inserted in the case body 21 and the opening 21c of the case body 21 is closed with the case lid 22. Subsequently, the case body 21 and the case lid 22 are welded to each other along the entire circumference of the case lid 22. Thus, the case 10 is completed. Subsequently, the electrolytic solution 80 is injected into the case 10 through a liquid inlet (not shown) of the case lid 22 and then this liquid inlet is sealed with a sealing member (not shown). Finally, this battery 1 is subjected to initial charging and various inspections. The battery 1 is thus completed.

In the battery 1 in the first embodiment, provided with the gas guiding members 40 and 50 as described above, jets of gas GA emerging from the peripheral facing surfaces 30e and 30f of the electrode body 30 toward the short side walls 15 and 16 are guided toward the safety valve 25 by the gas guiding members 40 and 50. Accordingly, the gas GA spouted from the electrode body 30 toward the short side walls 15 and 16 are prevented from breaking through the short side walls 15 and 16 of the case 10 and further going out of the case 10.

In the first embodiment, the gas guiding members 40 and 50 are gas guiding members that are separate from the case 10. These gas guiding members 40 and 50, separate bodies from the case 10, placed in the case 10 can avoid the gas GA spouted from the electrode body 30 from impinging on the case 10. This can efficiently prevent the spouted gas GA from breaking through the case 10 and further going out of the case 10.

In the first embodiment, furthermore, the gas guiding member 40 (50) includes the inclined surface 41m (51m) faces the entire range of the peripheral facing surface 30e (30f) of the electrode body 30 in the top-bottom direction AH. Accordingly, most of the gas spouted from the peripheral facing surface 30e (30f) of the electrode body 30 is guided to flow toward the top wall 11 along the inclined surface 41m (51m) up to the safety valve 25.

In the first embodiment, the inclination angle θ of the inclined surface 41m (51m) of the inclined portion 41 (51) is as large as 0.36° or more. Accordingly, this inclined surface 41m (51m) can guide the gas GA spouted from the peripheral facing surface 30e (30f) of the electrode body 30 to flow toward the top wall 11 and to the safety valve 25.

### Second to Fourth Embodiments

Next, second to fourth embodiments will be described below. In the following description, identical or similar parts to those in the first embodiment are not described or are roughly described. In the battery 1 in the first embodiment, the inclined surface 41m (51m) of the gas guiding member 40 (50) is a flat surface.

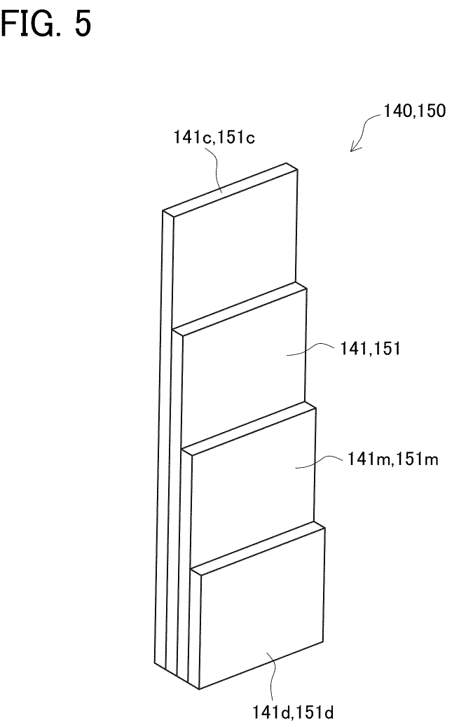

In contrast, in a battery 100 in the second embodiment, an inclined surface 141m (151m) of a gas guiding member 140 (150), i.e., of an inclined portion 141 (151), is a stepped surface as shown in FIG. 5. Specifically, the gas guiding member 140 (150), i.e., the inclined portion 141 (151), is made of rectangular plates (aluminum plates in the second embodiment) different in length, which are bonded to each other. Thus, the inclined portion 141 (151) has a thickness decreasing in a stepwise manner from a bottom end portion 141d (151d) to a top end portion 141c (151c). In the battery 100, accordingly, the gap between the inclined surface 141m (151m) and the peripheral facing surface 30e (30f) of the electrode body 30 is wider in a stepwise manner from the bottom wall 12 to the top wall 11.

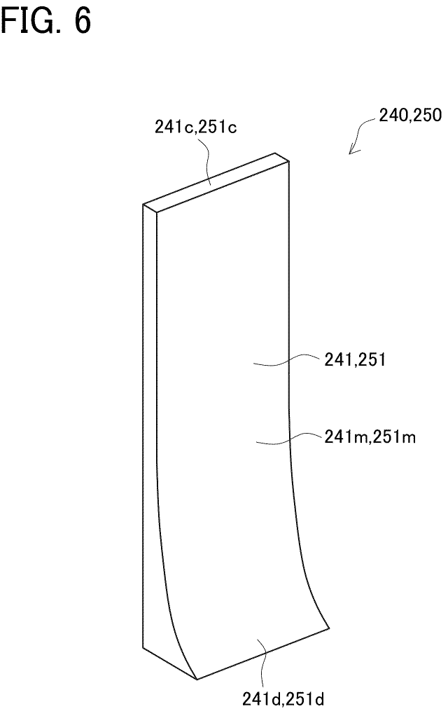

In a battery 200 in the third embodiment, an inclined surface 241m (251m) of a gas guiding member 240 (250), i.e., of an inclined portion 241 (251), is a curved surface as shown in FIG. 6. Specifically, the gas guiding member 240 (250), i.e., the inclined portion 241 (251), includes an inclined surface 241m (251m) that is a curved surface whose thickness sharply increases toward a bottom end portion 241d (251d), that is, gently decreases toward a top end portion 241c (251c). In the battery 200, accordingly, the gap between the inclined surface 241m (251m) and the peripheral facing surface 30e (30f) of the electrode body 30 is wider from the bottom wall 12 to the top wall 11.

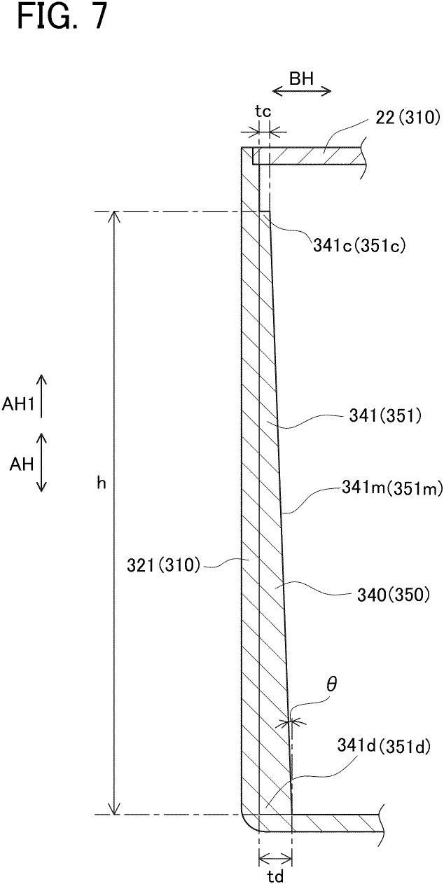

In a battery 300 in the fourth embodiment, a gas guiding part 340 (350) is integral with a case 310, concretely, integral with a case body 321, as shown in FIG. 7. Specifically, the gas guiding part 340 (350) including an inclined portion 341 (351) forming an inclined surface 341m (351m), which are similar in structure to the gas guiding part 40 (50) of the first embodiment, and the case body 21 of the first embodiment are integrated to constitute a case body 321 of the fourth embodiment. The inclined portion 341 (351) has a thickness decreasing from a bottom end portion 341d (351d) to a top end portion 341c (351c). In the battery 300, therefore, the gap between the inclined surface 341m (351m) and the peripheral facing surface 30e (30f) of the electrode body 30 is wider from the bottom wall 12 to the top wall 11.

In the above-described batteries 100, 200, and 300 in the second, third, and fourth embodiments, similarly, the gas guiding members 140, 150, 240, and 250 or the gas guiding parts 340 and 350 allow the gas GA spouted from the peripheral facing surfaces 30e and 30f of electrode body 30 toward the short side walls 15 and 16 to flow toward the top wall 11, i.e., the safety valve 25. This can prevent the gas GA from breaking through the short side walls 15 and 16 and further going out of the case 10 or 310. The identical or similar parts to those in the first embodiment can also provide the same operations and effects.

### Test Results

A test for verifying the effects of the present disclosure was conducted and test results are evaluated below. In Example 1, the battery 100 in the second embodiment (see FIG. 5) was prepared (also see Table 1). The gas guiding member 140 (150) of the battery 100 with the inclined surface 141m (151m) facing the entire range (100%) of the peripheral facing surface 30e (30f) of the electrode body 30 in the top-bottom direction AH. This is shown in the tile “Facing range” in Table 1.

In Examples 2 and 3, the batteries 100 of the first embodiment were prepared with the different gas guiding members 140 (150). Specifically, the gas guiding member in Example 2 has the inclined surface facing a range of 70% of peripheral facing surface 30e (30f) of the electrode body 30 in the top-bottom direction AH. The gas guiding member in Example 3 has the inclined surface facing a range of 50% of the peripheral facing surface 30e (30f) of the electrode body 30 in the top-bottom direction AH.

TABLE 1

| | | | | | | | | |
|---|---|---|---|---|---|---|---|---|
| | Presence/ absence of gas guiding member, etc. | Materials of gas guiding member, etc. | Facing range (%) | Top end thickness tc (mm) | Bottom end thickness td (mm) | Height h (mm) | Inclination angle θ (°) | Breakage of Short-side wall of Case |
| CE 1 | Absent | – | – | – | – | – | – | Yes |
| CE 2 | Flat plate member is present | Aluminum | 100 | 2.0 | 2.0 | 95 | 0 | Yes |
| Ex 1 | Gas guiding member is present | Aluminum | 100 | 0.5 | 2.0 | 95 | – | No |
| Ex 2 | ↑ | ↑ | 70 | ↑ | ↑ | 67 | – | No |
| Ex 3 | ↑ | ↑ | 50 | ↑ | ↑ | 48 | – | No |
| Ex 4 | ↑ | ↑ | 100 | 3.0 | 3.6 | 95 | 0.36 | No |
| Ex 5 | ↑ | ↑ | ↑ | 3.0 | 3.9 | ↑ | 0.54 | No |
| Ex 6 | ↑ | ↑ | ↑ | 0.1 | 10.0 | ↑ | 5.95 | No |
| Ex 7 | ↑ | ↑ | ↑ | 0.1 | 12.0 | ↑ | 7.14 | No |
| Ex 8 | ↑ | Alumina | 1 | 1.0 | 3.0 | ↑ | – | No |
| Ex 9 | ↑ | Zirconia | ↑ | ↑ | ↑ | ↑ | – | No |
| Ex 10 | ↑ | Stainless steel | ↑ | ↑ | ↑ | ↑ | – | No |

CE: Comparative example, Ex: Example, ↑: Same as above

In Comparative example 1, on the other hand, a battery including no gas guiding member was prepared, which corresponds to the battery 100 in Example battery 1 from which the gas guiding members 140 and 150 are eliminated.

In Comparative example 2, a battery including flat plate members each having no inclined surface (i.e., the inclination angle θ = 0°) instead of the gas guiding members 140 and 150 of the battery 100 of Example 1.

Furthermore, each of the batteries in Examples 1 to 3 and Comparative examples 1 and 2 was subjected to a nail penetration test under heated conditions, causing an internal short circuit in the electrode body 30 to generate a hot gas GA in the electrode body 30. After this nail penetration test, each electrode body 30 was examined whether the short side walls 15 and 16 of the case 10 were broken. Specifically, each battery charged to 100% SOC was heated to 60° C., and an iron round nail (size: N65, 3 mm in diameter) was pierced in the center of this heated battery to cause the generation of gas GA in the electrode body 30. After the nail penetration test, it was visually checked to see if the short side walls 15 and 16 of the case 10 were broken.

The results reveal that the short side walls 15 and 16 of the cases 10 in each battery in Comparative examples 1 and 2 were broken. In contrast, in each battery in Examples 1 to 3, the short side walls 15 and 16 of the case 10 were not broken, which may be considered for the following reasons.

Specifically, the battery in Comparative example 1 includes neither the gas guiding member nor the flat plate member between the peripheral facing surface 30e (30f) of the electrode body 30 and the short side wall 15 (16) of the case 310. This would conceivably have caused the gas GA spouted from the peripheral facing surface 30e (30f) of the electrode body 30 to impinge on the short side wall 15 (16) of the case 10 and further break through the short side wall 15 (16).

In the battery in Comparative example 2, since the flat plate member is placed between the peripheral facing surface 30e (30f) of the electrode body 30 and the short side wall 15 (16) of the case 10, it is possible to prevent the gas GA spouted from the peripheral facing surface 30e (30f) of the electrode body 30 from directly impinging on the short side wall 15 (16) of the case 10. However, the flat plate member does not guide the gas GA spouted from the peripheral facing surface 30e (30f) of the electrode body 30 toward the top wall 11, i.e., toward the safety valve 25. This would conceivably have caused this gas GA to break through the flat plate member and the short side wall 15 (16).

In each of the batteries in Examples 1 to 3, in contrast, the gas GA spouted from the peripheral facing surface 30e (30f) of the electrode body 30 toward the short side wall 15 (16) of the case 310 is guided by the gas guiding member toward the top wall 11, i.e., toward the safety valve 25. In particular, since the facing range of the inclined surface of the gas guiding member is 50% or more, much of the spouted gas GA is guided by the gas guiding member toward the top wall 11. This would have prevented the gas GA from breaking through the gas guiding member and the short side wall 15 (16) of the case 10.

In Examples 4 to 7, moreover, four types of batteries were prepared with different inclination angles θ of the inclined surface 41 m (51 m) by setting the top-end thickness tc and the bottom-end thickness td of the gas guiding member 40 (50) at different values. Specifically, as shown in Table 1, the inclination angles θ in Example 4, 5, 6, and 7 were respectively set to 0.36°, 0.54°, 5.95°, and 7.14°. These batteries were then subjected to the foregoing nail penetration test to inspect whether the short side wall 15 (16) of the case 10 was broken.

This test resulted that the short side wall 15 (16) of the case 10 in each of the batteries in Examples 4 to 7 was not broken. In each of these batteries, similarly, the gas GA spouted from the peripheral facing surface 30e (30f) of the electrode body 30 is guided by the gas guiding member toward the top wall 11, i.e., toward the safety valve 25. In particular, the inclination angle θ of the inclined surface is 0.36° or more, forming a large inclination, so that the gas GA is easily guided toward the top wall 11 (the safety valve 25). This would have prevented the gas GA spouted from the electrode body 30 from breaking through the gas guiding member and the short side wall 15 (16) of the case 10.

In Examples 8 to 10, three types of batteries were prepared with the gas guiding members 40 (50) made of different materials in the battery 100 of Example 1. Specifically, as shown in Table 1, the gas guiding member in Example 12 is made of alumina, the gas guiding member in Example 13 is made of zirconia, and the gas guiding member in Example 14 is made of stainless steel. Those batteries were subjected to the nail penetration test to inspect whether the short side wall 15 (16) of the case 10 was broken.

This test resulted that the short side wall 15 (16) of the case 10 in each of the batteries in Examples 12 to 14 was not broken. In each of these batteries, the gas GA spouted from the peripheral facing surface 30e (30f) of the electrode body 30 is guided by the gas guiding member toward the top wall 11, i.e., toward the safety valve 25. In particular, the gas guiding member is made of metal or ceramics, which resists to the temperature of the spouted gas GA for 10 seconds or more. This would have prevented the spouted gas GA from breaking through the gas guiding member and the short side wall 15 (16) of the case 10.

The present disclosure is described above in the first to fourth embodiments, but is not limited thereto. It should be understood that the present disclosure may be embodied in other specific forms without departing from the essential characteristics thereof.

For instance, the first to fourth embodiments exemplify the laminated electrode body 30 as an electrode body of the battery 1 and others, but are not limited thereto. For example, a wound electrode body may be adopted in which a strip-shaped positive electrode sheet and a strip-shaped negative electrode sheet are wound in a flat shape with strip-shaped separators interposed therebetween.

Reference Signs List

| | |
|---|---|
| 1, 100, 200, 300 | Battery (Power storage device) |
| 10, 310 | Case |
| 11 a | Long side |
| 11 b | Short side |
| 11 | Top wall |
| 12 | Bottom wall |
| 13, 14 | Long side wall |
| 15, 16 | Short side wall |
| 25 | Safety valve |
| 30 | Electrode body |
| 30c, 30d | Peripheral end surface |
| 30e, 30f | Peripheral end surface (Peripheral facing surface) |
| 31 | Positive electrode sheet (Electrode sheet) |
| 32 | Negative electrode sheet (Electrode sheet) |
| 33 | Separator |
| 33 c | Peripheral edge (of separator) |
| 40, 50, 140, 150, 240, 250 | Gas guiding member (Gas guiding part) |
| 340, 350 | Gas guiding part |
| 41, 51, 141, 151, 241, 251, 341, 351 | Inclined portion |
| 41m, 51m, 141m, 151m, 241m, 251m, 341m, 351m | Inclined surface |
| AH | Battery vertical direction (Top-bottom direction) |
| DH | Thickness direction (of electrode body) |
| GA | Gas |

What is claimed is:

1. A power storage device comprising:
an electrode body;
a case accommodating the electrode body;
a safety valve provided to the case and configured to release gas generated in the case to outside the case; and
a gas guiding part for guiding the gas toward the safety valve when the gas spouts from the electrode body.

2. The power storage device according to claim 1, wherein, the gas guiding part is formed of a gas guiding member that is a separate body from the case.

3. The power storage device according to claim 1, wherein,
the case has a rectangular parallelepiped box shape, and includes:
a rectangular top wall having a pair of long sides and a pair of short sides;
a rectangular bottom wall opposed to the top wall;
a pair of long side walls extending individually from the pair of long sides to join the top wall and the bottom wall; and
a pair of short side walls extending individually from the pair of short sides to join the top wall and the bottom wall,
the electrode body includes electrode sheets and separators, which overlap each other, in which the electrode sheets or the separators have peripheral end portions arranged in a thickness direction to form a pair of peripheral facing surfaces that face the pair of short side walls of the case,
the safety valve is placed on the top wall of the case, and
the gas guiding part is placed between the short side wall of the case and the peripheral facing surface of the electrode body and is configured to guide the gas toward the top wall when the gas spouts from the peripheral facing surface toward the short side wall.

4. The power storage device according to claim 2, wherein,
the case has a rectangular parallelepiped box shape, and includes:
a rectangular top wall having a pair of long sides and a pair of short sides;
a rectangular bottom wall opposed to the top wall;
a pair of long side walls extending individually from the pair of long sides to join the top wall and the bottom wall; and
a pair of short side walls extending individually from the pair of short sides to join the top wall and the bottom wall,
the electrode body includes electrode sheets and separators, which overlap each other, in which the electrode sheets or the separators have peripheral end portions arranged in a thickness direction to form a pair of peripheral facing surfaces that face the pair of short side walls of the case,
the safety valve is placed on the top wall of the case, and
the gas guiding part is placed between the short side wall of the case and the peripheral facing surface of the electrode body and is configured to guide the gas toward the top wall when the gas spouts from the peripheral facing surface toward the short side wall.

5. The power storage device according to claim 3, wherein,
the gas guiding part includes an inclined portion that:
faces over a range of 50% or more of the peripheral facing surface in a top-bottom direction of joining the top wall and the bottom wall; and
forms an inclined surface spaced from the peripheral facing surface with a gap wider toward the top wall.

6. The power storage device according to claim 4, wherein,
the gas guiding part includes an inclined portion that:
faces over a range of 50% or more of the peripheral facing surface in a top-bottom direction of joining the top wall and the bottom wall; and
forms an inclined surface spaced from the peripheral facing surface with a gap wider toward the top wall.

7. The power storage device according to claim 5, wherein, the gas guiding part includes the inclined portion that forms the inclined surface facing over all the range of the peripheral facing surface in the top-bottom direction.

8. The power storage device according to claim 6, wherein, the gas guiding part includes the inclined portion that forms the inclined surface facing over all the range of the peripheral facing surface in the top-bottom direction.

9. The power storage device according to claim 5, wherein,
the inclined surface of the inclined portion is a flat surface, and
the inclined surface has an inclination angle of 0.36° or more, the inclination angle being defined by an interior angle of a right triangle having an adjacent side corresponding to a height of the inclined portion and an opposite side corresponding to a difference between a bottom-end thickness of a bottom end portion of the inclined portion on a closest side to the bottom wall of the case and a top-end thickness of a top end portion of the inclined portion on a closest side to the top wall of the case.

10. The power storage device according to claim 6, wherein,
the inclined surface of the inclined portion is a flat surface, and
the inclined surface has an inclination angle of 0.36° or more, the inclination angle being defined by an interior angle of a right triangle having an adjacent side corresponding to a height of the inclined portion and an opposite side corresponding to a difference between a bottom-end thickness of a bottom end portion of the inclined portion on a closest side to the bottom wall of the case and a top-end thickness of a top end portion of the inclined portion on a closest side to the top wall of the case.

11. The power storage device according to claim 7, wherein,
the inclined surface of the inclined portion is a flat surface, and
the inclined surface has an inclination angle of 0.36° or more, the inclination angle being defined by an interior angle of a right triangle having an adjacent side corresponding to a height of the inclined portion and an opposite side corresponding to a difference between a bottom-end thickness of a bottom end portion of the inclined portion on a closest side to the bottom wall of the case and a top-end thickness of a top end portion of the inclined portion on a closest side to the top wall of the case.

12. The power storage device according to claim 8 wherein,
the inclined surface of the inclined portion is a flat surface, and
the inclined surface has an inclination angle of 0.36° or more, the inclination angle being defined by an interior angle of a right triangle having an adjacent side corresponding to a height of the inclined portion and an opposite side corresponding to a difference between a bottom-end thickness of a bottom end portion of the inclined portion on a closest side to the bottom wall of the case and a top-end thickness of a top end portion of the inclined portion on a closest side to the top wall of the case.
